(19) United States
(12) Patent Application Publication
(10) Pub. No.: US 2023/0411803 A1
(43) Pub. Date: Dec. 21, 2023

(54) Cylindrical Battery Electrode Plate and Cylindrical Battery

(71) Applicant: JIANGSU ZENERGY BATTERY TECHNOLOGIES CO., LTD., Jiangsu (CN)

(72) Inventors: Juntai LU, Jiangsu (CN); Lincong LAI, Jiangsu (CN); Jianliang WEI, Jiangsu (CN); Dandan CHEN, Jiangsu (CN)

(21) Appl. No.: 18/210,443

(22) Filed: Jun. 15, 2023

(30) Foreign Application Priority Data
Jun. 15, 2022 (CN) 202221492524.3

(51) Int. Cl. H01M 50/533; H01M 50/107; H01M 50/538

(52) U.S. Cl. CPC H01M 50/533; H01M 50/107; H01M 50/538

(57) ABSTRACT

The disclosure relates to the technical field of battery production and manufacture, in particular to a cylindrical battery electrode plate including a electrode plate body and a plurality of tabs provided on one side of the electrode plate body, wherein a gap area is provided between adjacent tabs of the plurality of tabs, each of the plurality of tabs is respectively provided with one or more slits extending along a surface thereof, a starting end of each of the slits is provided at one end, away from the electrode plate body, the extending direction of each of the slits is arranged to form an included angle with the arrangement direction of the plurality of tabs, and each of the plurality of tabs is divided into a plurality of sub-tabs by the slits.

### CROSS-REFERENCE TO RELATED APPLICATION

The disclosure claims priority to Chinese Patent Application No. 202221492524.3 filed to the China National Intellectual Property Administration on Jun. 15, 2022 and entitled “Cylindrical Battery Electrode Plate and Cylindrical Battery”, the disclosure of which is hereby incorporated by reference in its entirety.

### TECHNICAL FIELD

The disclosure relates to the technical field of battery production and manufacture, in particular to a cylindrical battery electrode plate and a cylindrical battery.

### BACKGROUND

Nowadays, with the development of modern society and the enhancement of people's awareness of environmental protection, more and more devices choose lithium-ion batteries as power sources, such as mobile phones, laptops, power tools and electro-mobiles, which provides a wide space for the application and development of lithium-ion batteries. Here, the lithium-ion battery is packaged in different forms as a cylindrical battery, a square battery and a pouch battery.

In the related art, a process of kneading tabs is mainly configured for the cylindrical battery, which requires a large pressure to be applied perpendicular to the surface of the electrode plate in order to flatten the two cylindrical end faces of the cylindrical battery formed after winding. However, metal filings are easily generated by kneading the tabs, which easily causes the active material on the inner positive and negative electrode plates to fall off, and even causes the deformation of the inner electrode plates, thus greatly reducing the safety of the product. Therefore, a new technical solution is urgently needed to solve the above-mentioned problems.

### SUMMARY

One of the objects of the disclosure is to provide a cylindrical battery electrode plate regarding the deficiencies of the related art, which is capable of ensuring that the tabs are spread and smoothed from one side thereof, effectively avoiding the occurrence of metal filings from kneading the tab.

In order to achieve the above object, the disclosure adopts the following technical solution:
a cylindrical battery electrode plate, including:
an electrode plate body and a plurality of tabs provided on one side of the electrode plate body, wherein a gap area is provided between adjacent tabs of the plurality of tabs;
each of the plurality of tabs has one or more slits respectively extending along a surface thereof, and a starting end of each of the slits is provided at an end, away from the electrode plate body;
the extending direction of each of the slits is arranged to form an included angle with the arrangement direction of the plurality of tabs, each of the plurality of tabs is divided into a plurality of sub-tabs by the slits.

In some embodiments, the extending directions of the slits are parallel to each other and are obliquely arranged on the arrangement directions of respective one of the plurality of tabs, thereby ensuring that the respective sub-tabs may be spread and smoothed from the same direction.

In some embodiments, there are multiple gap areas, the width of each of the multiple gap areas is unequal, i.e., the spacing between the non-tab areas is unequal, thereby enabling after winding the cylindrical battery electrode plate to ensure good and accurate alignment of a plurality of inner ring tabs and a plurality of outer ring tabs.

In some embodiments, the starting position and the ending position in the winding direction of the electrode plate body each has a non-tab area, and the tabs and the gap areas are alternately provided.

In some embodiments, the width of adjacent tabs of the plurality of tabs is equal or unequal so that the width of different tabs may be adjusted as required.

In some embodiments, one end of each of the plurality of tabs close to the electrode plate body has a stepped portion connected to the plurality of sub-tabs, the stepped portion is perpendicular to the electrode plate body, and a terminating end of each of the slits is located at an intersection of the plurality of sub-tabs and the stepped portion, and the stepped portion is configured for preventing the sub-tab from being inverted.

In some embodiments, the plurality of sub-tabs are obliquely arranged on the stepped portion so that both side edges of each of the plurality of sub-tabs are obliquely arranged on the stepped portion so that the spreading and smoothing effect of each of the plurality of sub-tabs is better.

In some embodiments, the widths of a part of the plurality of tabs provided along one side of the electrode plate body are equal, and when the widths of the part of the plurality of tabs are equal, die-cutting and welding of a part of the plurality of tabs are facilitated, and the plurality of tabs are formed a stepped electrical connection area on one side of the electrode plate body.

In some embodiments, in a same one of the plurality of tabs, each of the plurality of sub-tabs has the equal width, thereby facilitating the machining of the plurality of sub-tabs.

In some embodiments, the width of each of the plurality of tabs is sequentially increased along the arrangement direction thereof, so that the current passing capability of the tabs may be effectively increased.

In some embodiments, the horizontal heights of adjacent tabs of the plurality of tabs are equal or unequal, and when the horizontal heights of adjacent tabs of the plurality of tabs are unequal, the horizontal height of each of the plurality of tabs may be sequentially increased along the arrangement direction of the plurality of tabs, so that the top of the plurality of outer ring tabs is able to be folded over the plurality of inner ring tabs and form a stepped electrical connection area.

In some embodiments, the included angle between the arrangement direction of the plurality of tabs and the extending direction of the slits is 10°-85° to facilitate the adjustment of the spreading and smoothing effect of the tabs and the welding area between different tabs, and ensure that different tabs are welded firmly.

A second object of the disclosure is as follows: a cylindrical battery is provided including a cylindrical battery electrode plate as described above.

In some embodiments, a plurality of positive tabs and a plurality of negative tabs of the cylindrical battery are located on a same side of the cylindrical battery.

The beneficial effects of the disclosure are as follows: the battery electrode plate of the disclosure includes the electrode plate body and the plurality of tabs provided on one side of the electrode plate body, wherein adjacent tabs of the plurality of tabs have the gap area therebetween, and the gap area has an effect of facilitating the infiltration of the battery electrode plate by the electrolyte; each of the plurality of tabs has one or more slits extending along the surface of the tabs, the starting end of each of the slits is provided at the end of each of the plurality of tabs away from the electrode plate body, the extending direction of each of the slits is arranged to form an included angle with the arranging direction of the plurality of tabs, and each of the plurality of tabs is divided into a plurality of sub-tabs by the slits; since each of the plurality of tabs is divided and cut by the slits to obtain the plurality of sub-tabs which is able to be spread and smoothed in the pre-set direction, so that the kneading operation does not need to be performed after the electrode plate of the battery is wound into an cell, thereby avoiding metal filings and active substance falling off, and improving the safety of the product.

### BRIEF DESCRIPTION OF THE DRAWINGS

Features, advantages, and technical effects of exemplary embodiments of the disclosure will be described below with reference to the accompanying drawings.

FIG. 1 is a schematic structural diagram according to Embodiment 1 of the disclosure.

FIG. 2 is an enlarged view of a portion I in FIG. 1.

FIG. 3 is a schematic structural diagram according to Embodiment 4 of the disclosure.

FIG. 4 is a schematic structural diagram according to Embodiment 5 of the disclosure.

FIG. 5 is an enlarged view of a portion A in FIG. 4.

Herein, reference numerals are described as follows:
1—electrode plate body; 11—insulating substance layer; 12—active substance layer;
2—tab; 21—sub—tab; 22—stepped portion;
3—gap area;
4—slit;
T1—arrangement direction of the tab; T2—extending direction of the slit; α—included angle between the arrangement direction of the plurality of tabs and the extending direction of the slits.

### DETAILED DESCRIPTION OF THE EMBODIMENTS

Certain terms are used throughout the description and claims to refer to particular components. A person skilled in the art will appreciate that hardware manufacturers may refer to the same component by different terms. This description and claims do not use differences in names to distinguish between components, but rather use differences in functionality to distinguish between components. As used throughout the description and claims, the word “including” is open-ended, and thus should be interpreted to mean “including, but not limited to”. “Substantially” means a person skilled in the art would have been able to solve the technical problem within a certain error range and achieve the technical effect substantially within an acceptable error range.

In the disclosure, unless expressly specified and limited otherwise, the terms “mounted”, “coupled”, “connected”, “fixed” etc. are to be understood in a broad sense, e.g., as a fixed connection, as a detachable connection, or as an integral connection; may be a mechanical connection or an electrical connection; it may be directly connected or indirectly connected through an intermediate medium, and may be the communication between two elements. The specific meaning of the above terms in the disclosure may be understood by a person skilled in the art according to specific circumstances.

At present, a process with tabs arranging at two ends of each battery is usually used for the all-tab technology manufactured battery, and the size of each of the tabs is usually longer, such as the size of each of the tabs is 6-10 mm. This process with tabs arranging at two ends of each battery seriously wastes space at one end, so that the battery loses the certain energy density. In addition, in the related art, the tab kneading process is mainly used to treat the tabs of a cylindrical battery, and the tab kneading process is easy to generate metal filings, thus reducing product safety. For this reason, there is the need for an electrode plate that improves the safety and energy density of the battery by optimizing the structure of the tab.

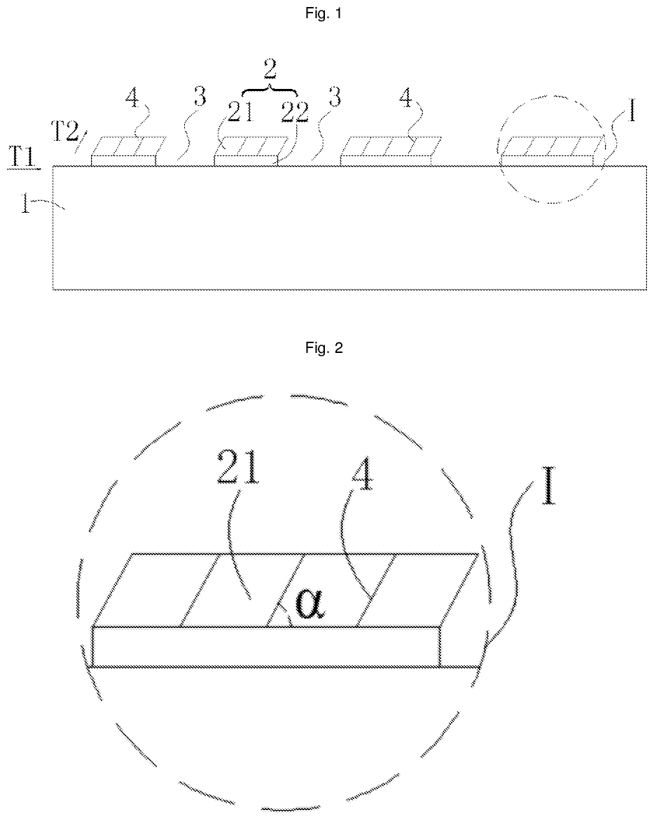

The disclosure is described in further detail below with reference to FIGS. 1-5 and the embodiments, but not as the limitation of the disclosure.

### Embodiment 1

Embodiment 1 will be described below with reference to FIG. 1
a cylindrical battery electrode plate, including:
a electrode plate body 1 and a plurality of tabs 2 provided on one side of the electrode plate body 1, wherein a gap area 3 is provided between adjacent tabs of the plurality of tabs 2;
each of the plurality of tabs 2 has one or more slits 4 respectively extending along a surface thereof, and the starting end of each of the slits 4 is provided at one end of each of the plurality of tabs 2 away from the electrode plate body 1;
in addition, the extending direction T2 of each of the slits 4 is arranged to form an included angle with the arrangement direction T1 of the tab 2, each of the plurality of tabs 2 is divided into a plurality of sub-tabs 21 along the extending direction T2 of the slit 4, the widths of adjacent sub-tabs 21 are equal or unequal, and the plurality of sub-tabs 21 are spread and smoothed in the pre-set direction.

The plurality of tabs 2 are provided on one side in the width direction of the electrode plate body 1, and after the electrode plate body 1 is wound from the arrangement direction T1 of the plurality of tabs 2 and forms an cell, since each of the plurality of tabs 2 is able to be divided and cut by the slits 4 to obtain the plurality of sub-tabs 21, by spreading and folding the plurality of sub-tabs 21, the structure of the tabs 2 is further optimized, and the metal filings produced by kneading the tabs are prevented, thus effectively improving the safety performance of the battery.

In the battery electrode plate, the widths of the adjacent tabs 2 of the plurality of tabs 2 are equal or unequal, and as shown in FIG. 2, the cut positions of each of the plurality of tabs 2 are the slits 4, and the extending directions T2 of each of the slits 4 are parallel to each other and are obliquely arranged on the arrangement direction T1 of the plurality of tabs 2, wherein an included angle α between the arrangement direction T1 of the plurality of tabs 2 along the electrode plate body 1 and the extending direction T2 of the slits 4 is 10°-85°, and specifically is 10°-35°, 35°-65° and 65°-85°, thereby effectively adjusting the inclination amplitude of each of the plurality of sub-tabs 21, so that each of the plurality of sub-tabs 21 flexibly achieves various spreading and smoothing effects.

In addition, in order to ensure that the plurality of tabs 2 wound around the electrode plate body 1 are well aligned, in the battery electrode plate, the width of each of the gap areas 3 is unequal, i.e., the spacing distances between the non-tabs are unequal, and the tabs 2 and the gap areas 3 are provided alternately.

In the battery electrode plate, in order to avoid each of the plurality of sub-tabs 21 being inserted into the electrode plate body 1 upside down to cause a short circuit, the end of each of the plurality of tabs 2 close to the electrode plate body 1 has a stepped portion 22 connected to the plurality sub-tabs 21, the stepped portion 22 is perpendicular to the electrode plate body 1, the terminating end of each of the slits 4 is located at the intersection of the respective one of the sub-tab 21 and the stepped portion 22, wherein the height of the sub-tab 21 is equal to the height of the slit 4 which is greater than or equal to the height of the stepped portion 22. In an embodiment, the stepped portion 22 is able to be a rectangular configuration.

In the battery electrode plate, the plurality of sub-tabs 21 are obliquely arranged on the stepped portion 22, wherein both side edges of each of the plurality of sub-tabs 21 are obliquely arranged on the stepped portion 22, so that the plurality of sub-tabs 21 are able to be spread and smoothed and the plurality of sub-tabs 21 are able to be prevented from being inverted.

In an embodiment, in order to make the alignment degree of the plurality of tabs 2 high and form a stepped structure, the width of each of the plurality of tabs 2 is able to be sequentially increased along the arrangement direction T1 of the plurality of tabs 2.

In the battery electrode plate, in order to facilitate the die-cutting of partial tabs 2 of the plurality of tabs 2, the widths of the partial tabs 2 provided along one side of the electrode plate body 1 are equal.

In an embodiment, in order to improve the current passing capability of the battery, starting from the first tab 2 of the plurality of tabs 2, along the arrangement direction T1 of the plurality of tabs 2, N adjacent tabs 2 of the plurality of tabs 2 are in a unit, N is greater than 1, there are X units, X is greater than 1, the width of each of the N adjacent tabs 2 of each unit is the same, and along the arrangement direction T1 of the N adjacent tabs 2, the widths of the tabs in the first unit are smaller than the widths of the tabs in the second unit, are smaller than the widths of the tabs in the third units up to the widths of the tabs in the X^{th} unit. For example: in the arrangement direction T1 of the plurality of tabs 2, the widths of the four sequentially provided tabs 2 in the electrode plate are made equal, and the widths of the next four sequentially provided tabs 2 are made larger by the same width.

### Embodiment 2

In contrast to the Embodiment 1, a part of the plurality of tabs 2 provided along one side of the electrode plate body 1 has the same number of slits 4, and each of the plurality of sub-tabs 21 has the equal width in the same one of the plurality of tabs 2, thereby facilitating the processing of the plurality of sub-tabs 21.

Other structures are the same as those of Embodiment 1, and will not be described in detail herein.

### Embodiment 3

In contrast to Embodiment 1 or 2, the horizontal heights of adjacent tabs of the plurality of tabs 2 are unequal, and the horizontal heights of the tabs 2 are successively increase along the arrangement direction T1 of the plurality of tabs 2; when the electrode plate body 1 is wound from the arrangement direction T1 of the plurality of tabs 2 and forms an cell, the tops of the tabs 2 of the outer ring are folded over the tabs 2 of the inner ring, so that the end faces of the plurality of tabs 2 are ensured to be flat, and a desired spreading and smoothing effect are achieved.

The other structures are the same as those of the first or second embodiment, which is not described herein.

### Embodiment 4

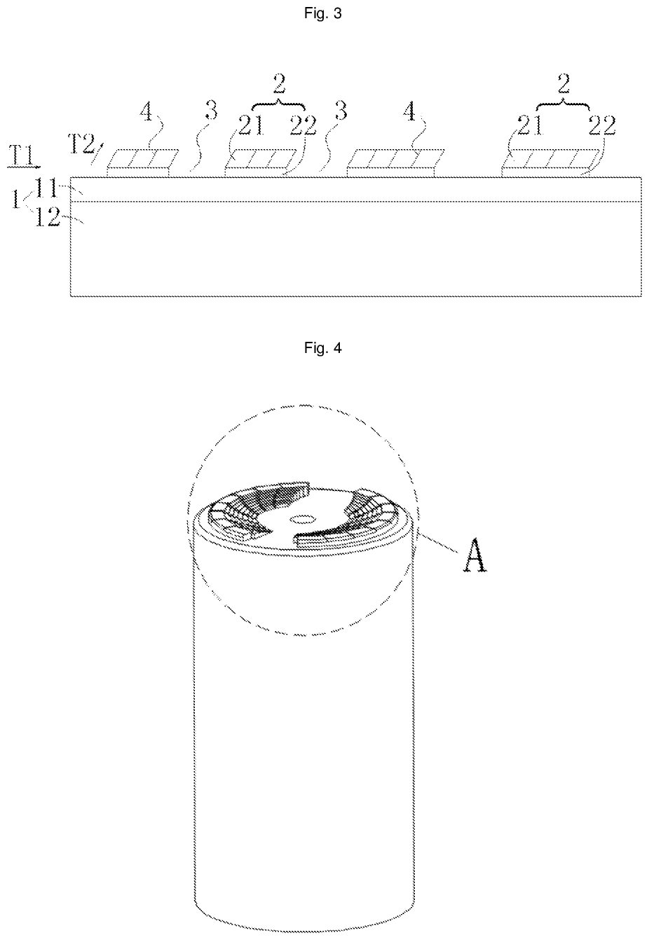

In contrast to the Embodiments 1 to 3: referring to FIG. 3, the electrode plate body 1 has an insulating substance layer 11 and an active substance layer 12, wherein a stepped portion 22 of each of the plurality of tabs 2 is connected to the insulating substance layer 11, the active substance layer 12 is provided on a side of the insulating substance layer 11 away from the stepped portion 22, and the insulating substance layer 11 is able to separate electrode plates of the different polarity to prevent a contact short circuit from occurring during winding of electrode plates of different polarities.

The other structures are the same as Embodiments 1 to 3, which is not described herein.

### Embodiment 5

Referring to FIG. 4, the cylindrical battery includes a cylindrical battery electrode plate according to any one of Embodiments 1 to 4, wherein the electrode plate and a separator in the cylindrical battery are wound to form the cell, and a plurality of positive tabs and a plurality of negative tabs of the cylindrical battery are located on a same side of the cylindrical battery.

Specifically, the positive electrode plate of the cylindrical battery is able to the cylindrical battery electrode plate of any one of Embodiments 1 to 4, and in the positive electrode plate, the material of the positive tab area is able to be aluminum foil, i.e., each of the plurality of sub-tabs 21 and the stepped portion 22 is made from aluminum foil, wherein the positive tab area has an insulating substance layer 11, and at the same time, the height of the slit 4 thereof is 4.5 mm-6 mm, and the height of the stepped portion 22 thereof is 2 mm-3 mm; the negative electrode plate of the cylindrical battery is able to be a cylindrical battery electrode plate according to any one of Embodiments 1 to 4, and in the negative electrode plate, the material of the negative tab area is able to be a copper foil, i.e. each of the plurality of sub-tabs 21 and the stepped portion 22 is a copper foil, and the electrode plate body 1 thereof only has the active substance layer 12, and at the same time, the height of the slit 4 thereof is 5.5 mm-6.5 mm, and the height of the stepped portion 22 thereof is 1 mm-2 mm.

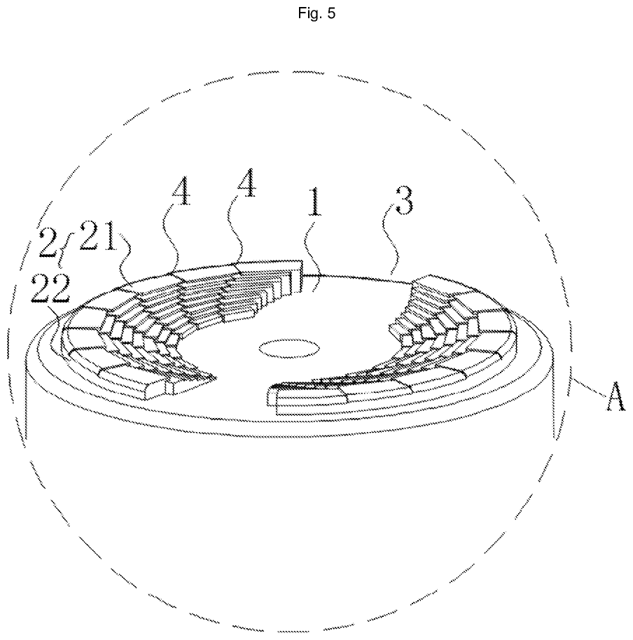

When the positive electrode plate and the negative electrode plate are wound, a structure in which the positive electrode and the negative electrode are on the same side of the cell as shown in FIG. 5 is formed, with the left side of the top of the cell being the positive electrode and the right side of the top of the cell being the negative electrode. Such structure not only effectively avoids wasting space at one end due to the tabs going out of two ends of the cell, thus resulting in a loss of energy density, but also enables the positive electrode and the negative electrode to be output at one end of the cell due to the short size of the tab of the battery, thus effectively saving space inside the battery.

Further, the battery is a cylindrical battery of any size, and the cylindrical battery is able to be a lithium-ion battery, a sodium ion battery, a sodium lithium-ion battery, a magnesium ion battery, or the like.

### Embodiment 6

An electric device including the battery of Embodiment 5, wherein the electric device is a vehicle, a mobile phone, a portable device, a laptop, a ship, a spacecraft, an electric toy, or a power tool, etc. The vehicle is a fuel automobile, a gas automobile or a new energy automobile, and the new energy automobile is a pure electric automobile, a hybrid automobile or an extended range automobile, etc.; the spacecrafts include an airplane, a rocket, a spaceflight, a spacecraft, etc.; the electric toys include a fixed or mobile electric toy, such as a game machine, an electro-mobile toy, an electric ship toy, an electric aircraft toy, etc.; the electric tools include metal a cutting electric tool, a grinding electric tool, an assembling electric tool, and a railway electric tool, for example, an electric drill, an electric grinder, an electric wrench, an electric screwdriver, an electric hammer, an impact electric drill, a concrete vibrator, an electric planer, etc. The embodiment of the present application does not specifically limit the above-mentioned electric device.

According to the disclosure and teaching of the above description, a person skilled in the art of the disclosure may make changes and modifications to the above-mentioned embodiments. Therefore, the disclosure is not limited to the above-mentioned embodiments, and any obvious improvements, substitutions or modifications made by a person skilled in the art on the basis of the disclosure fall within the scope of protection of the disclosure. In addition, although specific terms are used in the description, these terms are configured for convenience only and do not limit the disclosure.

What is claimed is:

1. A cylindrical battery electrode plate, comprising:
a electrode plate body and a plurality of tabs provided on one side of the electrode plate body, wherein a gap area is provided between adjacent tabs of the plurality of tabs;
each of the plurality of tabs has one or more slits respectively extending along a surface thereof, and a starting end of each of the slits is provided at an end, away from the electrode plate body;
the extending direction of each of the slits is arranged to form an included angle with the arrangement direction of the plurality of tabs, and each of the plurality of tabs is divided into a plurality of sub-tabs by the slits.

2. The cylindrical battery electrode plate according to claim 1, wherein the extending directions of the slits are parallel to each other and are obliquely arranged on the arrangement directions of respective one of the plurality of tabs.

3. The cylindrical battery electrode plate according to claim 1, wherein there are multiple gap areas, the width of each of the multiple gap areas is unequal, and the widths of adjacent tabs of the plurality of tabs are equal or unequal.

4. The cylindrical battery electrode plate according to claim 1, wherein one end of each of the plurality of tabs close to the electrode plate body has a stepped portion connected to the plurality of sub-tabs, the stepped portion is perpendicular to the electrode plate body, and a terminating end of each of the slits is located at an intersection of the plurality of sub-tabs and the stepped portion.

5. The cylindrical battery electrode plate according to claim 4, wherein the plurality of sub-tabs are obliquely arranged on the stepped portion.

6. The cylindrical battery electrode plate according to claim 3, wherein the widths of a part of the plurality of tabs provided along one side of the electrode plate body are equal.

7. The cylindrical battery electrode plate according to claim 6, wherein in a same one of the plurality of tabs, each of the plurality of sub-tabs has the equal width.

8. The cylindrical battery electrode plate according to claim 1, wherein the included angle between the arrangement direction of the plurality of tabs and the extending direction of the slits is 10°-85°.

9. A cylindrical battery, comprising the cylindrical battery electrode plate according to claim 1.

10. The cylindrical battery according to claim 9, wherein a plurality of positive tabs and a plurality of negative tabs of the cylindrical battery are located on a same side of the cylindrical battery.

11. The cylindrical battery electrode plate according to claim 2, wherein one end of each of the plurality of tabs close to the electrode plate body has a stepped portion connected to the plurality of sub-tabs, the stepped portion is perpendicular to the electrode plate body, and a terminating end of each of the slits is located at an intersection of the plurality of sub-tabs and the stepped portion.

12. The cylindrical battery electrode plate according to claim 3, wherein one end of each of the plurality of tabs close to the electrode plate body has a stepped portion connected to the plurality of sub-tabs, the stepped portion is perpendicular to the electrode plate body, and a terminating end of each of the slits is located at an intersection of the plurality of sub-tabs and the stepped portion.

13. The cylindrical battery electrode plate according to claim 2, wherein the included angle between the arrangement direction of the plurality of tabs and the extending direction of the slits is 10°-85°.

14. The cylindrical battery according to claim 9, wherein the extending directions of the slits are parallel to each other and are obliquely arranged on the arrangement directions of respective one of the plurality of tabs.

15. The cylindrical battery according to claim 9, wherein there are multiple gap areas, the width of each of the multiple gap areas is unequal, and the widths of adjacent tabs of the plurality of tabs are equal or unequal.

16. The cylindrical battery according to claim 9, wherein end of each of the plurality of tabs close to the electrode plate body has a stepped portion connected to the plurality of sub-tabs, the stepped portion is perpendicular to the electrode plate body, and a terminating end of each of the slits is located at an intersection of the plurality of sub-tabs and the stepped portion.

17. The cylindrical battery according to claim 16, wherein the plurality of sub-tabs are obliquely arranged on the stepped portion.

18. The cylindrical battery according to claim 15, wherein the widths of a part of the plurality of tabs provided along one side of the electrode plate body are equal.

19. The cylindrical battery according to claim 18, wherein in a same one of the plurality of tabs, each of the plurality of sub-tabs has the equal width.

20. The cylindrical battery according to claim 9, wherein the included angle between the arrangement direction of the plurality of tabs and the extending direction of the slits is 10°-85°.
